(19) United States
(12) Patent Application Publication
(10) Pub. No.: US 2008/0019312 A1
(43) Pub. Date: Jan. 24, 2008

(54) EFFICIENT MECHANISMS FOR MAPPING HARQ CONNECTIONS TO MAC LAYER CONNECTIONS AND SCHEDULING IN THE PRESENCE OF HARQ

(76) Inventors: Muthaiah Venkatachalam, Beaverton, OR (US); Xiangying Yang, Portland, OR (US)

Correspondence Address: SCHWEGMAN, LUNDBERG & WOESSNER, P.A., P.O. BOX 2938, MINNEAPOLIS, MN, 55402, US

(21) Appl. No.: 11/458,188

(22) Filed: Jul. 18, 2006

(51) Int. Cl. H04Q 7/00

(52) U.S. Cl. 370/330

(57) ABSTRACT

Embodiments of mapping a HARQ enabled MAC layer connection into multiple HARQ connections and scheduling packet transmission via the HARQ connections in mechanisms are described generally herein. Other embodiments may be described and claimed.

### TECHNICAL FIELD

Various embodiments described herein relate generally to digital communications, including apparatus, systems, and methods used in wireless communications.

### BACKGROUND INFORMATION

An evolving family of standards is being developed by the Institute of Electrical and Electronic Engineers (IEEE) to define parameters of a point-to-multipoint wireless, packet-switched communications system. In particular, the 802.16 family of standards (e.g., the IEEE std. 802.16-2004 (published Sep. 18, 2004)) may provide for fixed, portable, and/or mobile broadband wireless access networks. Additional information regarding the IEEE 802.16 standard may be found in IEEE Standard for Local and Metropolitan Area Networks—Part 16: Air Interface for Fixed Broadband Wireless Access Systems (published Oct. 1, 2004). See also IEEE 802.16E-2005, IEEE Standard for Local and Metropolitan Area Networks—Part 16: Air Interface for Fixed and Mobile Broadband Wireless Access Systems—Amendment for Physical and Medium Access Control Layers for Combined Fixed and Mobile Operation in Licensed Bands (published Feb. 28, 2006). Further, the Worldwide Interoperability for Microwave Access (WiMAX) Forum facilitates the deployment of broadband wireless networks based on the IEEE 802.16 standards. For convenience, the terms “802.16” and “WiMAX” (WiMAX is a trademark of the WiMAX Forum) may be used interchangeably throughout this disclosure to refer to the IEEE 802.16 suite of air interface standards.

Wireless communication between two wireless devices may experience packet errors. The WiMAX Forum has proposed a hybrid automatic repeat request (“HARQ”) protocol to attempt to recover corrupted packets, which for example may take the implementation of either chase combining (CC) or incremental redundancy (IR). When a device employing HARQ receives a corrupted packet, it sends a packet transmission failure to the sender. The sender may retransmit the packet or a correlated version. The device then may attempt to determine the original packet by combining the previously received, corrupted packet with the new packet. Accordingly, devices employing HARQ may be required to stop-and-wait after each packet transmission for package transmission status prior to transmitting additional packets to another wireless device. Such a protocol may reduce the effective physical channel bandwidth between HARQ enabled devices. In addition WiMAX devices may be required to support HARQ enabled and non-HARQ enabled devices, which may cause packet scheduling complexity.

### BRIEF DESCRIPTION OF THE DRAWINGS

FIG. 1 is a block diagram of a wireless communication architecture comprising wireless devices according to various embodiments.

FIG. 2 is a diagram of channel communications between a wireless device and a base station according to various embodiments.

FIG. 3 is a block diagram of a wireless device according to various embodiments.

FIG. 4 is a block diagram of a wireless communication base station according to various embodiments.

FIG. 5A is a diagram of a base station media access control (“MAC”) layer connection packet queue according to various embodiments.

FIG. 5B is a diagram of a base station HARQ connection status/request queue according to various embodiments.

FIG. 6 is a diagram of channel communications between a wireless device and a base station according to various embodiments.

FIG. 7 is a diagram of channel communications between several wireless devices and a base station according to various embodiments.

FIG. 8 is a diagram of a base station HARQ connection status/request queue according to various embodiments.

FIG. 9 is a flow diagram illustrating several methods according to various embodiments.

FIG. 10 is a flow diagram illustrating several methods according to various embodiments.

FIG. 11 is a diagram of a base station MAC layer connection time packet received queue according to various embodiments.

### DETAILED DESCRIPTION

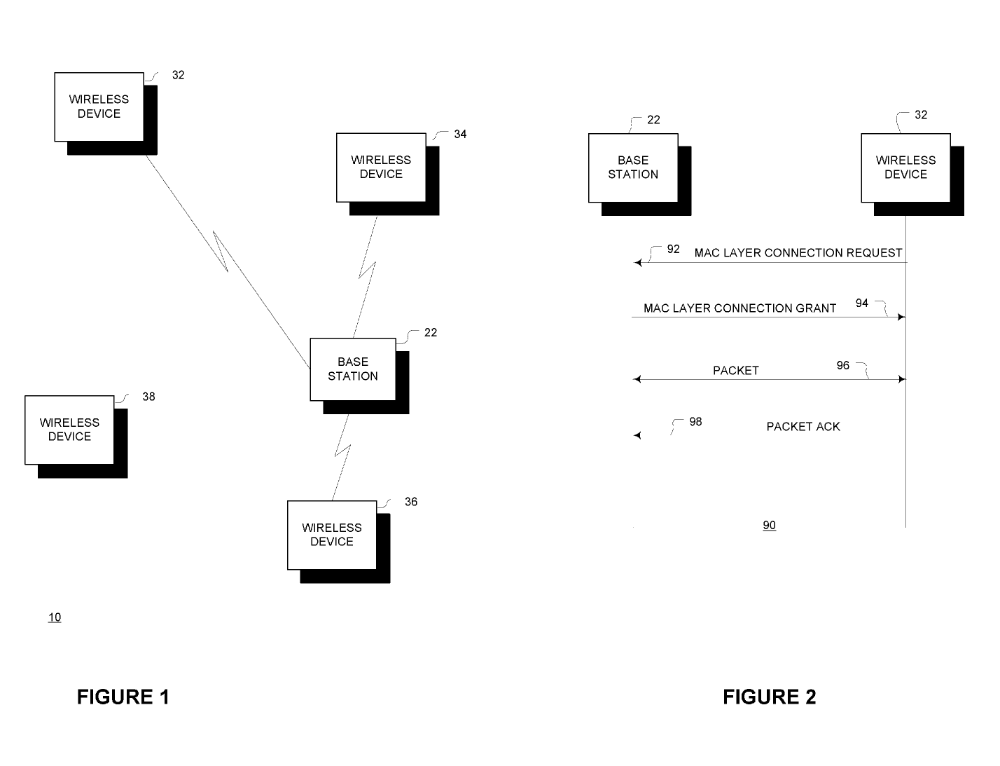

FIG. 1 is a block diagram of a wireless communication architecture 10 comprising wireless devices (“WD”) 32, 34, 36, 38 and a wireless communication base station (“BS”) 22 according to various embodiments. Each WD 32, 34, 36, 38 may be able to establish a wireless channel between itself and the BS 22. Embodiments of a WD 32 and a BS 22 herein may optimize HARQ protocols and operate efficiently with any combination of HARQ and non-HARQ enabled WDs 32, 34, 36, 38. Such embodiments may be employed in wireless architecture where a WD 32 may communicate directly with one or more other WD 34, 36, 38. The WD 32, 34, 36, 38 and the BS 22 may be capable of operating according to an IEEE 802.11 family of standards and/or according to an IEEE 802.16 family of standards.

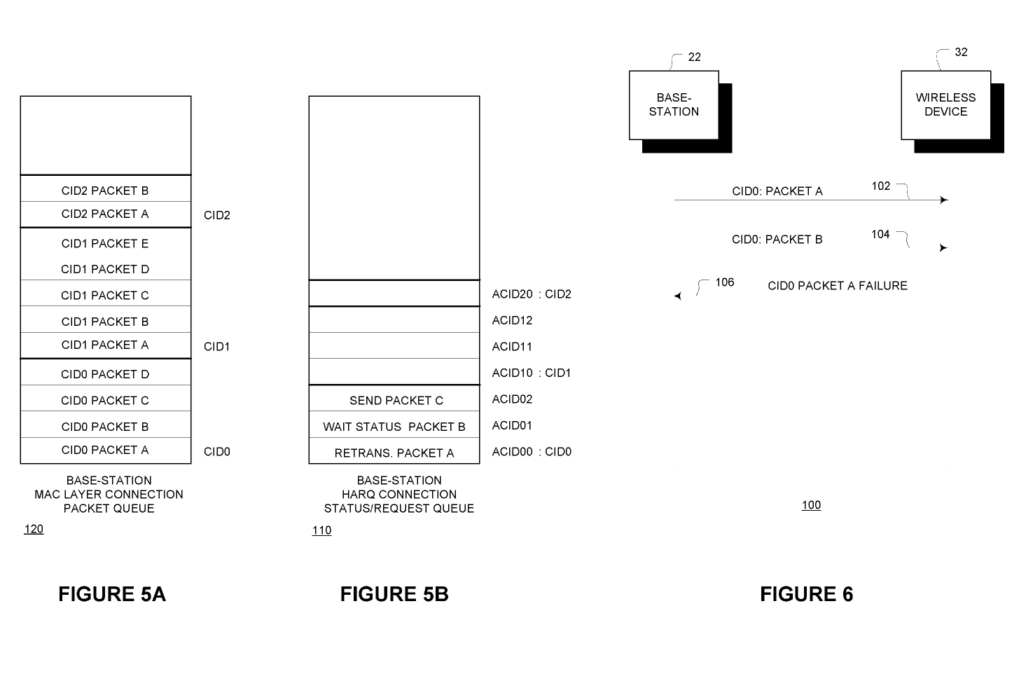

FIG. 2 is a diagram of a channel communications 90 between a WD 32 and a BS 22 according to various embodiments. In an embodiment, the WD 32 may request communication with the BS 22 via a MAC layer connection request 92 or related message. The BS 22 may grant 94 the requested connection to create or establish a physical channel between the WD 32 and itself (depending on protocols, security, and relationship between the WD 32 and the BS 22). Packets 96 may be communicated between the BS 22 and the WD 32. In an embodiment, the WD 32 may acknowledge successful or failed packet transmission 98. Embodiments of the BS 22 and the WD 32 may employ a MAC layer connection packet queue 120, a HARQ connection status/request queue 110, and a MAC layer connection time packet received queue 190, such as shown in FIG. 5A, 5B, 11 to manage physical channel(s) between the BS 22 or the WD 32 and other wireless devices. The methods and apparatus described herein may implemented in other suitable type of wireless communication networks such as a wireless mesh network. For example, the WD 32 may request communication with another WD such as 34, 36, and/or 38.

In an embodiment, a BS 22 may create a MAC layer connection, CID0, CID1, CID2 (shown, for example, in FIG. 5A) for each wireless packet physical channel between the BS 22 and one or more WDs 32, 34, 36, and/or 38. In an embodiment, a WD 32 may request and be granted multiple physical channels from a BS 22. Each physical channel may have an associated quality of service (“QoS”) requested and assigned in an embodiment. In an embodiment, each physical channel has a corresponding MAC layer connection. In some communication protocols, the corresponding MAC layer connection may be required to support HARQ where a HARQ enabled MAC layer connection may require successful packet transmission acknowledgement 98 before a new packet 96 may be transmitted.

In an embodiment, a BS 22 or WD 32 maps each HARQ enabled MAC layer connection CIDi into multiple HARQ connections ACIDi0, ACIDi1, . . . , ACIDiN. In an embodiment the HARQ connection status/request queue 110 (FIG. 5B) has three instances (N=2) or mappings for each HARQ enabled MAC layer connection (CIDi). The CIDi mappings are termed ACIDi0, ACIDi1, and ACIDi2. In an embodiment a non-HARQ enabled MAC layer connection may be assigned a single mapping, such as ACID20 for MAC layer connection CID2.

In an embodiment, the number of HARQ connections created for each MAC layer connection may be unique (for each MAC layer connection). The number of HARQ connections created for a particular MAC layer connection may be determined as a function of the number of frames needed to receive packet transmission status in the MAC layer connection. In an embodiment, when a BS 22 transmits a packet to a WD 32, the WD 32 transmits packet receipt status in N frames. In this embodiment, the BS 22 may assign or map N+1 HARQ connections for the MAC layer connection. In another embodiment, the number of HARQ connections may be determined as a function of the MAC layer connection (CIDi) bandwidth requirement (“Breq”), transmission status latency (“TSlat”), and packet size (“PS”). In an embodiment, the number of HARQ connections is set to the floor of (Breq*TSlat)/PS for the corresponding MAC layer connection.

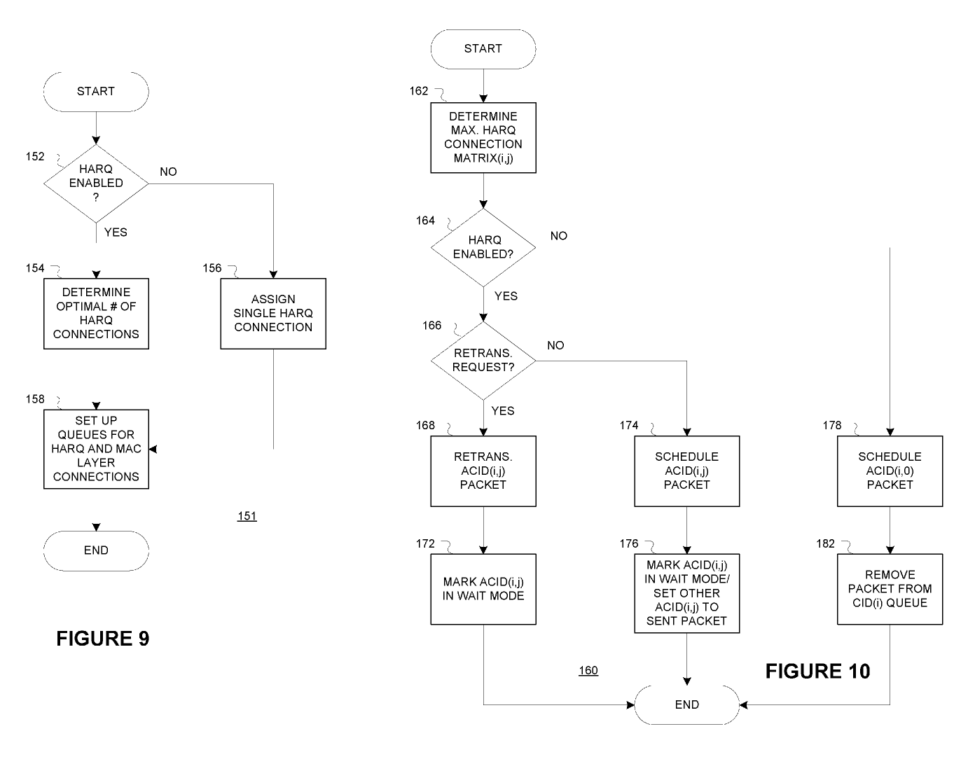

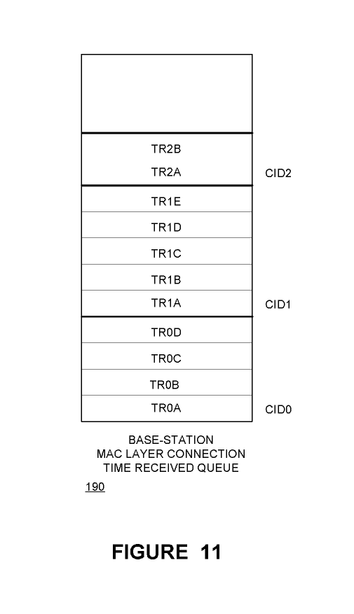

FIG. 9 is a flow diagram of a MAC layer connection to HARQ connections mapping method 151 according to various embodiments. The method 151 may determine whether the corresponding MAC layer connection is HARQ enabled (activity 152). In an embodiment, the MAC layer connection request 92 may include an indication of the HARQ capability. In an embodiment, the method 151 may generate a single HARQ connection for non-HARQ enabled MAC layer connections (activity 156). Otherwise, the method 151 may determine and assign the optimal number of HARQ connections for a HARQ enabled MAC layer connection (activity 154). Then the MAC layer connection packet queue 120 (FIG. 5A), HARQ connection status/request queue 110 (FIG. 5B), and MAC layer connection time packet received queue 190 (FIG. 11) may be generated (activity 158) based on the number of HARQ connections mapped for the MAC layer connection (activities 154 and 156).

Referring to FIG. 6, for a HARQ enabled MAC layer connection CID0, a first packet A 102 and a second packet B 104 may be sent before waiting for receipt of packet A transmission status 106. A HARQ connection status/request queue 110 (FIG. 5B) may track the status of each HARQ connection. In an embodiment, after receiving the CID0 packet A failure transmission 106, HARQ connection ACID00 may be updated to the next desired event for the ACID00, in this example retransmit packet A. HARQ connection ACID01 may be in a stop-and-wait mode for packet B (packet B sent 104 to the WD 32). HARQ connection ACID02 may be requesting transmission of packet C.

In FIG. 5B, MAC layer connection CID1 has also been mapped into three HARQ connections ACID10, ACID11, ACID 12. MAC layer connection CID2 is not HARQ-enabled; it has been mapped into a single HARQ connection, ACID20. In an embodiment, non-HARQ enabled MAC layer connections may also be mapped into multiple HARQ connections. In this embodiment, the multiple HARQ connection for non-HARQ MAC layer connections may help balance scheduling priorities between non-HARQ enabled and HARQ enabled MAC layer connections.

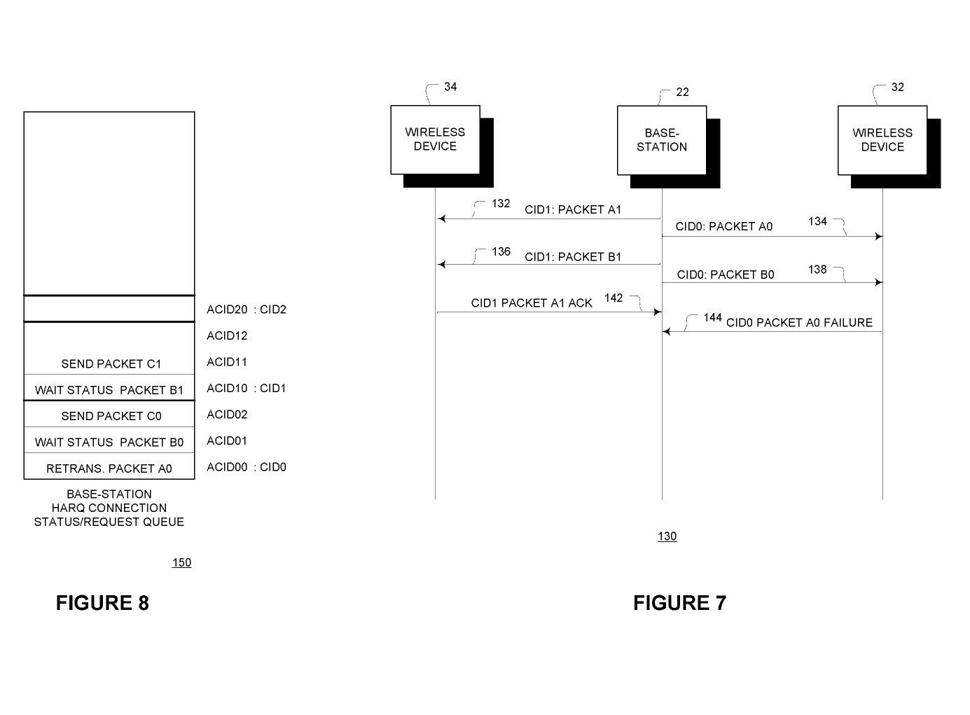

FIG. 7 depicts an embodiment of MAC layer connections CID1 and CID0 130 for a BS 22, where CID0 and CID1 are MAC layer connections between the BS 22 and WDs 32, 34, respectively. FIG. 8 depicts an embodiment of a HARQ connection status/request queue 150 for the BS 22 shown in FIG. 7. In this embodiment, the BS 22 has attempted to send packets A1, B1 to the WD 34 (132, 136) and packets A0, B0 to the WD 32 (134, 138). The BS 22 has received transmission status for packet A1 from the WD 34 (142) and for packet A0 from the WD 32 (144).

In an embodiment, the MAC layer connection CID1 between the BS 22 and the WD 34 has been mapped into three HARQ connections where two are currently active: ACID10 and ACID11 (FIG. 8). In this embodiment, HARQ connection ACID 10 is waiting for packet B1 transmission status and HARQ connection ACID 11 is requesting transmission of packet C1. In an embodiment, the MAC layer connection CID0 between the BS 22 and the WD 32 has been mapped into three HARQ connections where three are currently active: ACID00, ACID01, and ACID02 (FIG. 8). In this embodiment, HARQ connection ACID10 is requesting retransmission of packet A0, HARQ connection ACID01 is waiting for packet B0 transmission status, and HARQ connection ACID02 is requesting transmission of packet C1 (FIG. 8).

In an embodiment, HARQ connections that represent requests for packet retransmissions, such as ACID00, may be assigned a higher priority for slot assignment than HARQ connections that represent requests for new packet transmission, such as ACID02 or ACID10. Such an embodiment may limit the bandwidth of MAC layer connections that have fewer retransmission requests (fewer packet errors) than other MAC layer connections. In an embodiment, when both a MAC layer connection packet queue 120 is not empty (packets are waiting to be transmitted), and one or more transmission slots (bandwidth exists for BS 22) are available, the embodiment may determine priority metric value for HARQ connection whose current status is not “wait for packet” status. In the embodiment shown in FIG. 7 and 8, priority metric values may be determined for HARQ connections ACID00, ACID02, and ACID11.

In an embodiment, the method 160 shown in FIG. 10 may be employed to schedule one or more packets for transmission on one or more available BS slots in a wireless architecture employing HARQ. The method 160 may determine which HARQ connection has the largest priority metric value (activity 162). In an embodiment each HARQ connection's priority metric value is determined as a function of its and the corresponding MAC layer connection's signal to noise and interference ration (“SINR”), the corresponding MAC layer connection acceptable channel delay, and the corresponding MAC layer queue length (number of packets awaiting transmission on the MAC layer connection).

In an embodiment, the priority metric(i,j) value of a HARQ connection ACIDi,j (such as metric(0,0) for HARQ connection ACID00) is equal to F1*F2*F3, where F1 is a normalized SINR function for HARQ connection and related MAC layer connection, F2 is a delay deadline weighting function for the HARQ connection, and F3 is multiple of the related MAC layer connection (CIDi) queue length (120 in FIG. 5A). In an embodiment:

$${F}_{1} = \frac{{\sum }_{{K}_{ij}} {SNR}_{ij} ( k )}{{SNRavg}_{i}} , {F}_{2} = max ( 100 , \frac{1}{D {max}_{i} - {D}_{ij}} ) , {F}_{3} = Qi$$

In an embodiment, the SINRᵢⱼ(k) is equal to the effective SINR detected for packet communications for HARQ connection ACID(i,j) after HARQ combining of k retransmissions. In an embodiment, the BS 22 may detect or receive SINR information for each packet transmission. The SINRavg(i) is equal to the average SINR for the MAC layer connection CID(i), averaged over all transmissions for MAC layer connection. Other similar functions based on SINRᵢⱼ(k) and SINRavg(i) can be used to determine F1. One such example is the effective and active rate calculated as log(1+SINR). Dmax(i) is maximum acceptable delay for a MAC layer connection CID(i). Dmax(i) may be determined from the QoS for the MAC layer connection or be included in the MAC layer connection request 92 (FIG. 2).

In an embodiment, each packet for a MAC layer connection is time stamped, and its time stamp may be stored in a MAC layer connection time request queue such as queue 190 shown in FIG. 11. Accordingly D(i,j), the current delay for a packet that a HARQ connection is requesting transmission for, may be determined by the current system time and the packet's corresponding time stamp in the MAC layer connection time request queue 190. Q(i) is equal to a multiple (which could be fractional) of the MAC layer connection CID(i) current packet queue length (queue 120 in FIG. 5A).

Referring again to FIG. 10, the priority metric value may be determined for each active HARQ connection in an embodiment, and the HARQ connection having the largest priority metric value may be selected for scheduling (activity 162) or several HARQ connections having the highest metric values may be scheduled together in an embodiment. The method may then determine whether the HARQ connection to be scheduled represents a HARQ enabled MAC layer connection (activity 164). When the HARQ connection to be scheduled does not represent a HARQ enabled MAC layer connection, the method 160 may schedule a packet in the packet queue 120 (FIG. 5A) requested by the HARQ connection (ACID(i,0)) and then remove the corresponding packet from the MAC layer connection packet queue (activities 178, 182).

When the HARQ connection to be scheduled represents a HARQ enabled MAC layer connection, the method 160 may determine whether the packet transmission request is a retransmission request (activity 166). When the packet transmission request is a retransmission request, the method 160 may schedule the HARQ connection requested retransmission packet for transmission, and mark the HARQ connection status/ready queue entry as “waiting for packet transmission” status (activities 168, 172). In the method 160, another HARQ connection of the MAC layer connection is not activated. Activation of another HARQ connection for packet transmission may cause the MAC layer connection to be locked in a stop-and-wait mode for all the mapped HARQ connections when N+1 HARQ connections are mapped for a MAC layer connection and N is equal to the number of frames required to receive a packet status back from a wireless WD.

When the packet transmission request is not a retransmission request (activity 166), the method 160 may schedule the HARQ connection ACID(i,j) requested packet for transmission, mark the HARQ connection status/ready queue entry as “waiting,” and enable another HARQ connection of the MAC layer connection to request transmission of the next packet in the MAC layer connection CID(i) queue 120 (activities 174, 176).

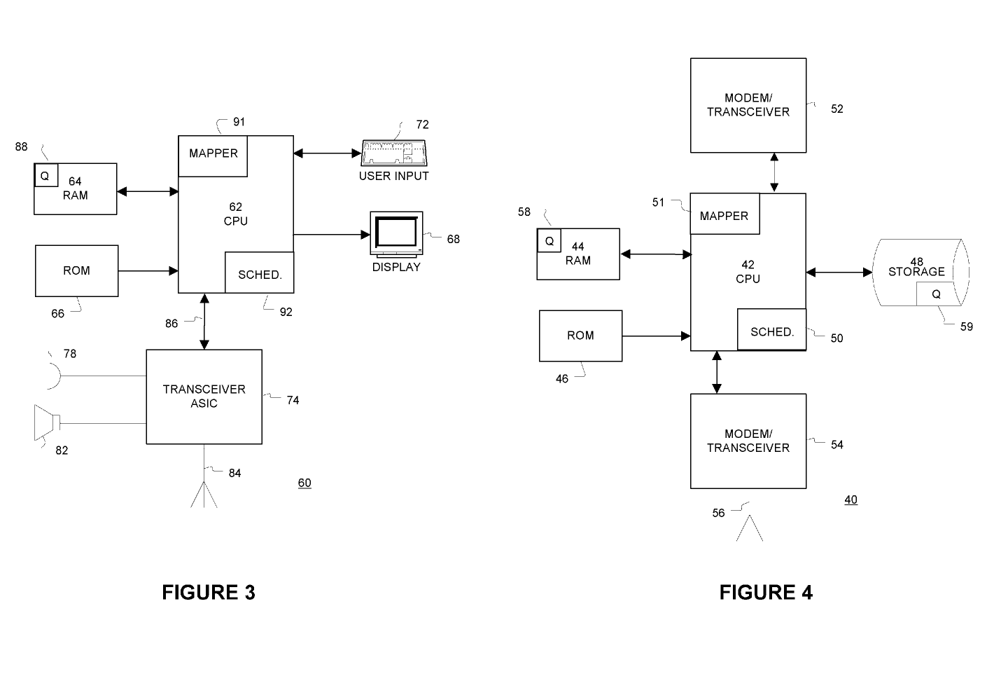

A device 60 is shown in FIG. 3 that may be used in various embodiments as a wireless device 32, 34, 36, 38. The device 60 may include a central processing unit (CPU) 62, a random access memory (RAM) 64, a read only memory (ROM”) 66, a display 68, a user input device 72, a transceiver application specific integrated circuit (ASIC) 74, a microphone 78, a speaker 82, and an antenna 84. The CPU 62 may include a scheduler 92 and a HARQ connection mapper 91. The RAM 64 may be include a queue 88 that may be used to store the MAC layer connection packet queue 120, MAC layer connection time packet received queue 190, and HARQ connection status/request queue 150. In an embodiment, the scheduler 92 and the mapper 91 may be separate elements. The HARQ connection mapper 91 may map a MAC layer connection into N HARQ connections, where N may be based on the corresponding physical channel bandwidth (of the MAC layer connection) or the number of frames needed to receive a status receipt for a packet transmitted to a WD. The scheduler 92 may determine which HARQ connection transmission request should be scheduled for the next available transmission slot as a function of the HARQ connection SINR, the related MAC layer connection SINR, and the MAC layer connection time received queue and packet queue (the queues stored in the queue 88.) The scheduler 92 may schedule the selected HARQ connection packet transmission request and update the HARQ connection status/request queue entry.

The ROM 66 is coupled to the CPU 62 and may store the program instructions executed by the CPU 62, the HARQ connection mapper 91, and the scheduler 92. The RAM 64 is coupled to the CPU 62 and stores temporary program data, overhead information, and queues 120, 150, 190. The user input device 72 may comprise an input device such as a keypad, touch pad screen, track ball or other similar input device that allows the user to navigate through menus in order to operate the device 60. The display 68 may be an output device such as a CRT, LCD or other similar screen display that enables the user to read, view, or hear received, processed data packets.

The microphone 78 and the speaker 82 may be incorporated into the device 60. The microphone 78 and the speaker 82 may also be separated from the device 60. Received data may be transmitted to the CPU 62 via a serial bus 86 where the data may include packets received, packets to be transmitted, or protocol information. The transceiver ASIC 74 may include an instruction set necessary to communicate data signals over the wireless architecture 10 (FIG. 1). In one embodiment, the transceiver ASIC 74 is capable of communicating over a WiMAX HARQ enabled network. The ASIC 74 may be coupled to the antenna 84 to communicate signals within the architecture 10. When a data signal is received by the transceiver ASIC 74, the data is transferred to the CPU 62 via the serial bus 86. The data can include base station protocol, overhead information, and packets to be processed by the device 60 in accordance with the methods described herein.

FIG. 4 illustrates a block diagram of a device 40 that may be employed as a BS 22 in various embodiments. The device 40 may include a CPU 42, a RAM 44, a ROM 46, a storage unit 48, a first modem/transceiver 52 and a second modem/transceiver 54. The CPU 42 may include a scheduler 50 and a HARQ connection mapper 51. The RAM 44 may include a queue 58, where the queue 58 may be used to store the MAC layer connection packet queue 120 (FIG. 5A), MAC layer connection time packet received queue 190 (FIG. 11), and HARQ connection status/request queue 150 (FIG. 8). The storage 48 may also include a queue 59 where the queue 59 may be used to store the MAC layer connection packet queue 120, MAC layer connection time packet received queue 190, and HARQ connection status/request queue 150. In an embodiment the scheduler 50 and the HARQ connection mapper 51 may be separate elements.

The HARQ connection mapper 51 may map a MAC layer connection into N HARQ connections, where N may be based on the corresponding physical channel bandwidth (of the MAC layer connection) or the number of frames needed to receive a status receipt for a packet transmitted to a WD. The scheduler 50 may determine which HARQ connection transmission request should be scheduled for the next available transmission slot as a function of the HARQ connection SINR, the related MAC layer connection SINR, and the MAC layer connection time received queue and packet queue (the queues stored in the queue 58 or 59). The scheduler 50 may schedule the selected HARQ connection packet transmission request and update the corresponding HARQ connection status/request queue entry.

The first modem/transceiver 52 may couple, in a well-known manner, the device 40 to an Internet connection or via a wired telephone system such as the Plain Old Telephone System (POTS). The second modem/transceiver 54 may couple the device 40 to the wireless architecture 10. The modem/transceiver 54 may be a wireless modem or other communication device that communicates with WD 32, 34, 36, 38 in the wireless architecture 10 (FIG. 1). The CPU 42 via the scheduler 50 may direct communication between the first and second modem, 52 and 54, respectively, for messages between the Internet, or POTS, and one or more WDs.

The ROM 46 may store program instructions to be executed by the CPU 42, HARQ connection mapper 51, or scheduler 50. The RAM 44 and storage 48 may be used to store temporary program information, wireless protocols, queues, and overhead information for other base stations in its sector (i.e., nearby base stations). The storage device 48 may comprise any convenient form of data storage and may be used to store the overhead information, wireless protocols, and queues.

Any of the components previously described can be implemented in a number of ways, including embodiments in software. Thus, the CPU 42, scheduler 50, mapper 51, modem/transceiver 54, modem/transceiver 52, antenna 56, storage 48, RAM 44, ROM 46, queue 58, queue 59, CPU 62, scheduler 92, mapper 91, transceiver ASIC 74, antenna 84, microphone 78, speaker 82, ROM 66, RAM 64, queue 88, user input 72, display 68, BS 22, WD 32, 34, 36, and 38 may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than optimizing HARQ enabled communication and related scheduling. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

Although the inventive concept may include embodiments described in the exemplary context of an IEEE standard 802.xx implementation (e.g., 802.11, 802.11a, 802.11b, 802.11E, 802.11g, 802.16, etc.), the claims are not so limited. Additional information regarding the IEEE 802.11a protocol standard may be found in IEEE Std 802.11a, Supplement to IEEE Standard for Information technology—Telecommunications and information exchange between systems—Local and metropolitan area networks—Specific requirements Part 11: Wireless LAN Medium Access Control (MAC) and Physical Layer (PHY) specifications—High-speed Physical Layer in the 5 GHz Band (published 1999; reaffirmed Jun. 12, 2003). Additional information regarding the IEEE 802.11b protocol standard may be found in IEEE Std 802.11b, Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: Higher-Speed Physical Layer Extension in the 2.4 GHz Band (approved Sep. 16, 1999; reaffirmed Jun. 12, 2003). Additional information regarding the IEEE 802.11g protocol standard may be found in IEEE Std 802.11g, IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band (approved Jun. 12, 2003). Embodiments of the present invention may be implemented as part of any wired or wireless system. Examples may also include embodiments comprising multi-carrier wireless communication channels (e.g., orthogonal frequency division multiplexing (OFDM), discrete multitone (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A wireless packet layer connection control module, including:
a mapper to map a wireless packet layer connection into a predetermined number of hybrid connections, each hybrid connection capable of requesting a wireless packet transmission, the predetermined number being greater than one; and
a scheduler to schedule packets for transmission on the wireless packet layer connection based on requests of the predetermined number of hybrid connections.

2. The wireless packet layer connection control module of claim 1, wherein a wireless device receiving a scheduled packet generates and sends a status packet, the status package indicating whether the received scheduled packet had errors.

3. The wireless packet layer connection control module of claim 2, wherein the predetermined number is based on the number of frames that pass after a scheduled packet transmission to a wireless device and receipt of a status packet for the scheduled packet transmission from the wireless device.

4. The wireless packet layer connection control module of claim 1, the scheduler to prioritize packet transmission requests of the predetermined number of hybrid connections based on the predetermined number of hybrid connections signal to noise ratio in past packet transmissions and the packet delay.

5. The wireless packet layer connection control module of claim 1, further including a queue to store the status of each of the predetermined number of hybrid connections.

6. The wireless packet layer connection control module of claim 5, wherein the status of each of the predetermined number of hybrid connections may include requesting retransmission of a packet, requesting transmission of a new packet, and waiting for status packet for a packet sent by request by the hybrid connection.

7. A system, including:
a wireless modem to transmit packets to a wireless device and receive status packets from the wireless device; and
a wireless packet layer connection control module, comprising:
a mapper to map a wireless packet layer connection into a predetermined number of hybrid connections, each hybrid connection capable of requesting a wireless packet transmission, the predetermined number being greater than one; and
a scheduler to schedule packets for transmission on the wireless packet layer connection based on requests of the predetermined number of hybrid connections.

8. The system of claim 7, wherein the system is integrated into at least one of a device capable of operating according to an Institute of Electrical and Electronics Engineers (IEEE) 802.11 family of standards, or a device capable of operating according to an IEEE 802.16 family of standards.

9. The system of claim 7, wherein the predetermined number is based on the number of frames that pass after a scheduled packet transmission to the wireless device and receipt of a status packet for the scheduled packet transmission from the wireless device.

10. The system of claim 7, the wireless packet layer connection control module further including a queue to store the status of each of the predetermined number of hybrid connections.

11. A method, including:
at a wireless device (WD) in a wireless packet-switched network, mapping a wireless packet layer connection between the WD and another wireless device in the network into a predetermined number of hybrid connections, each hybrid connection being capable of requesting a wireless packet transmission to the other wireless device, the predetermined number being greater than one; and
at the WD, scheduling packets for transmission on the wireless packet layer connection between the WD and the other WD based on the requests of the predetermined number of hybrid connections.

12. The method of claim 11, further including:
at the WD, setting one of the predetermined number of hybrid connections to request transmission of a received first packet for the other WD.

13. The method of claim 12, further including:
at the WD, scheduling the request of the one of the predetermined number of hybrid connections to transmit the first packet for the other WD.

14. The method of claim 13, further including:
at the WD, after scheduling the request of the one of the predetermined number of hybrid connections to transmit the first packet for the other WD, setting the one of the predetermined hybrid connections to wait for a status packet from the other WD.

15. The method of claim 11, further including:
at the other WD, sending a status packet to the WD, the status packet indicating whether a packet received from the WD had errors.

16. The method of claim 12, further including:
at the WD, setting the one of the predetermined hybrid connections that requested transmission of the first packet to request transmission of one the original first packet and a correlated packet to another WD when the status packet from the other WD indicates that the first packet had errors.

17. The method of claim 11, further including:
at the WD, prioritizing packet transmission requests of the predetermined number of hybrid connections based on the predetermined number of hybrid connections signal to noise ratio in past packet transmissions.

18. The method of claim 12, further including:
at the WD, prioritizing packet transmission requests of the predetermined number of hybrid connections based on the predetermined number of hybrid connections signal to noise ratio in past packet transmissions and the packet delay.

19. An article including a machine-accessible medium having associated information, wherein the information, when accessed, results in a machine performing:
at a wireless device (WD) in a wireless packet-switched network, mapping a wireless packet layer connection between the WD and another wireless device in the network into a predetermined number of hybrid connections, each hybrid connection capable of requesting a wireless packet transmission to the other wireless device, the predetermined number being greater than one; and
at the WD, scheduling packets for transmission on the wireless packet layer connection between the WD and the other WD based on the requests of the predetermined number of hybrid connections.

20. The article of claim 19, wherein the information, when accessed, results in a machine performing:
at the WD, setting one of the predetermined number of hybrid connections to request transmission of a received first packet for the other WD.

21. The article of claim 20, wherein the information, when accessed, results in a machine performing:
at the WD, scheduling the request of the one of the predetermined number of hybrid connections to transmit the first packet for the other WD.

22. The article of claim 21, wherein the information, when accessed, results in a machine performing:
at the WD, after scheduling the request of the one of the predetermined number of hybrid connections to transmit the first packet for the other WD, setting the one of the predetermined hybrid connections to wait for a status packet from the other WD.

23. The article of claim 19, wherein the information, when accessed, results in a machine performing:
at the WD, prioritizing packet transmission requests of the predetermined number of hybrid connections based on the predetermined number of hybrid connections signal to noise ratio in past packet transmissions.
